(19) United States
(12) Patent Application Publication
(10) Pub. No.: US 2003/0046081 A1
(43) Pub. Date: Mar. 6, 2003

(54) Auto attendant system and its method and call forwarding method using speech recognition

(76) Inventors: Myung-Wan Koo, Seoul (LR); Moon-Sik Kim, Seoul (KR); Hee-Kyung Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,595

(22) Filed: Dec. 28, 2000

(30) Foreign Application Priority Data
Oct. 6, 2000 (KR) 2000-58803

(51) Int. Cl. G10L 21/00

(52) U.S. Cl. 704/270

(57) ABSTRACT

Disclosed are an auto attendant system and its method and a call forwarding method using a speech recognition. The auto attendant system according to the invention includes first storing unit for storing information on a subscriber, a first call processing unit for receiving a recognizable name of the subscriber to be communicated with from a user to transfer the same to first speech recognizing unit, and searching the information on the subscriber from the first storing unit to connect a call to a destination number of the subscriber based on the searched information on the subscriber, and first speech recognizing unit for transferring the result of the recognized speech to the first call processing unit by recognizing the speech transferred from the first call processing unit.

### FIELD OF THE INVENTION

The present invention relates to an auto attendant system and its method and a call forwarding method using a speech recognition, and in particular, to an auto attendant system and its method using a speech recognition for promptly connecting a call to a person to be communicated with by recognizing the speech of the calling person and a method for easily setting/releasing a call forwarding irrespective of the location of a subscriber who desires the call forwarding by recognizing the speech as well as a recording medium containing a program readable by a computer to realize the same methods.

### DESCRIPTION OF THE PRIOR ART

FIG. 1 is a block diagram illustrating a construction of the conventional auto attendant system, particularly a relationship among the auto attendant system 102, users 105, 106 and subscribers 106 to 109.

An auto attendant system is a system installed at companies or schools for guidance of calls. A user is first connected to the system through a wire or wireless telephone. Following a guidance of the system, the user presses a button corresponding to a department or a person to be communicated with. The user's call is then extended to the corresponding department or the person.

Each of the subscribers 106 to 109 becomes a called person whose data are registered in the auto attendant system 102. The users 105, 106 may be all the users who desire to call a subscriber through the auto attendant system 102.

The auto attendant system 102 keeps information on each subscriber as a database 104, which stores recognizable names, classified index values and telephone numbers, etc. of the subscribers.

A call processing section 103 connects a user to a subscriber by either receiving a telephone number of a subscriber desiring to communicate with the user or by letting the user to select a subscriber in a similar manner and searching a telephone number of the corresponding subscriber from the database 104 of the subscribers.

FIG. 2 is a flow chart of the conventional auto attending method showing that, once the users 105, 106 input information on the subscriber to be communicated with upon guidance, the users 105, 106 are automatically connected to the subscriber.

If a user accesses to the auto attendant system 102, the auto attendant system transmits an introductory message to the user, and enlists department names of the subscribers registered in the auto attendant system so that the user can select a desired department name for communication at step 201.

If a button corresponding to the desired department name is inputted at step 202, the auto attendant system announces names of the subscribers pertaining to the department so that the user can select a subscriber at step 203.

The user then inputs a button corresponding to the subscriber to be communicated with at step 205.

Assuming that the above auto attendant system is installed in a campus of a university to provide services for professors, for example, three input steps are required such as “selection of a college→selection of a department→selection of a professor”. In this procedure, more steps will be required as an organization has a more complicated structure or more members.

Once a subscriber to be communicated with is selected by the user, the call of the user is connected to the selected subscriber through dialing the telephone number at step 206.

If the auto attendant system 102 is connected to an private automatic branch exchange (PABX) system 101, and if the selected subscriber has a destination number connected through PABX, the auto attendant system enables the user to communicate with the selected subscriber by pressing a hook button and inputting the telephone number of the selected subscriber, while releasing itself from the connection so as to be available by another user.

In case that the selected subscriber 109 has an external destination number, the auto attendant system connects itself to the selected subscriber's external destination number by using another line, and connects the line of the user to the selected subscriber. In case that the auto attendant system has been installed in a public network, the same process is performed.

If the subscriber registered in the auto attendant system desires a call forwarding due to some reasons, the subscriber holds up a telephone receiver, and presses the buttons “*88”, inputs the telephone number to be destined, and presses the button “*” again. Then, a signal is sounded to confirm the setting of a call forwarding. Thereafter, the subscriber can receive calls at the newly set telephone number.

In the above case, however, the setting and releasing can be performed through the subscriber's own telephone. When using PABX, the setting of a call forwarding can be performed only through the PABX line to be destined, while the releasing of the call forwarding can be performed through the subscriber's own telephone. The methods of setting and releasing the call forwarding are variable depending on the kinds of PABX systems.

If the auto attendant system 102 is installed inside of the PABX network 100, and the user desires to communicate with a subscriber B 108 who has set call forwarding not to an inside number but to an outside number, certain kinds of PABX systems cannot provide normal services but causes a back-ring to the auto attendant system. As a result, the user is unexpectedly connected to the auto attendant system again. In other words, if the user is not directly connected the subscriber B's telephone but connected to more than one telephone, the user cannot be connected to the subscriber whose destination has been forwarded outside. Therefore, it is impossible to connect the subscriber by means of the auto attendant system.

To resolve this problem, a connection to an externally transferred destination number can be successfully performed if applying the same method as processing an outside call to processing an inside call. However, considering the fact that the auto attendant system mainly performs a role of connecting the inside calls, the line connected to the auto attendant system becomes unavailable until termination of the engaged communication if applying the method of processing the outside call. Here, the inside call means a call exchanged within the PABX, and the outside call means a call of which a destination is outside of the PABX.

Furthermore, a special function needs to be added to the call forwarding service for use of the relevant service. Since setting and releasing can be performed through the subscriber's own telephone line, the subscriber should set the call forwarding before moving his/her location. Thus, setting or releasing of a call forwarding cannot be performed once after the subscriber moves to another place.

### SUMMARY OF THE INVENTION

It is, therefore, an object of the present invention to provide an auto attendant system and a method using speech recognition for promptly connecting a call to a person to be communicated with by recognizing the speech of the calling person and a method for easily setting/releasing call forwarding irrespective of the location of a subscriber who desires a call forwarding by using speech recognition as well as a recording medium containing a program to realize the same methods that can be read by a computer.

To achieve the above object, in accordance with an aspect of the present invention, there is provided an auto attendant system, comprising: first storing means for storing information on a subscriber; first call processing means for receiving a recognizable name of the subscriber to be communicated with from a user to transfer the same to first speech recognizing means, and searching the information on the subscriber from the first storing means to connect a call to a destination number of the subscriber based on the searched information on the subscriber; and first speech recognizing means for transferring the result of the recognized speech to the first call processing means by recognizing the speech transferred from the first call processing means.

The auto attendant system further includes second storing means for storing information on a call forwarding; second call processing means for receiving an intention for a call forwarding of calls to the subscriber, a recognizable name of the subscriber and new information on a call forwarding through speech to transfer the same to second speech recognizing means, receiving the result of the recognized speech from the second speech recognizing means, searching the information on call forwarding of the subscriber from the second storing means to change the same to the information on the new call forwarding, and connecting the call to the subscriber based on the changed information on the call forwarding; and second speech recognizing means for recognizing the speech transferred from the second call processing means to transfer the result of the recognized speech to the second call processing means.

In accordance with another aspect of the present invention, there is also provided an auto attending method applicable to the auto attendant system, comprising the steps of: a) receiving a recognizable name of the subscriber to be communicated with from the user for recognition of the inputted name; and b) connecting a call to the destined telephone number of the subscriber based on the recognized name and stored information on the subscriber. The auto attending method according to the present invention further includes the step of: c) receiving the recognizable name of the subscriber through auxiliary input means according to a selection of the user to connect the call to the destined telephone number of the subscriber based on the inputted information and the stored information on the subscriber.

The auto attending method also includes the steps of: a) receiving an intention for a call forwarding of calls to a subscriber, a recognizable name of the subscriber and new information on a call forwarding through speech for recognition of the same; and b) searching the stored information on call forwarding of the subscriber based on the recognized intention for a call forwarding and the recognizable name of the subscriber to change the searched information on a call forwarding to new information on a call forwarding, and connecting a call to the subscriber based on the changed information on a call forwarding.

The auto attending method further includes the step of: c) receiving the intention for a call forwarding of the calls to the subscriber, the recognizable name of the subscriber and the new information on a call forwarding according to a selection of the subscriber through auxiliary input means, searching the stored information on a call forwarding of the subscriber based on the inputted intention for a call forwarding and the recognizable name of the subscriber to change the same to new information on a call forwarding, and connecting the calls to the subscriber based on the changed information on a call forwarding.

In accordance with further another aspect of the present invention, there is provided the auto attendant system including a processor with a recording medium containing a program readable by a computer to realize: a first function of receiving a recognizable name of a subscriber to be communicated with from a user through speech for recognition of the same; and a second function of connecting the calls to the subscriber to the destined telephone number based on the recognized name and the stored information on the subscriber.

The present invention further provides the auto attendant system including a processor for a call forwarding with a recording medium readable by a computer to realize: a first function of receiving an intention for a call forwarding, a recognizable name of the subscriber to be communicated with, and new information on a call forwarding through speech from the subscriber for recognition of the same; and a second function of searching the stored information on a call forwarding of the subscriber based on the recognized intention for a call forwarding and the recognizable name of the subscriber to change the same to new information on a call forwarding, and connecting the calls to the subscriber based on the changed information on a call forwarding.

### BRIEF DESCRIPTION OF THE DRAWINGS

The above and other objects, features and advantages of the present invention will become more apparent from the following description when taken in conjunction with the accompanying drawings, in which:

FIG. 1 is a block diagram illustrating a construction of the conventional auto attendant system;

FIG. 2 is a flow chart illustrating the conventional method of providing an auto attendant service;

FIG. 3 is a block diagram illustrating a construction of an auto attendant system using a speech recognition according to an embodiment of the present invention;

FIGS. 4A and 4B are flow charts illustrating an auto attending method using a speech recognition according to an embodiment of the present invention; and

FIGS. 5A and 5B are flow charts illustrating a call forwarding method through a speech recognition according to an embodiment of the present invention.

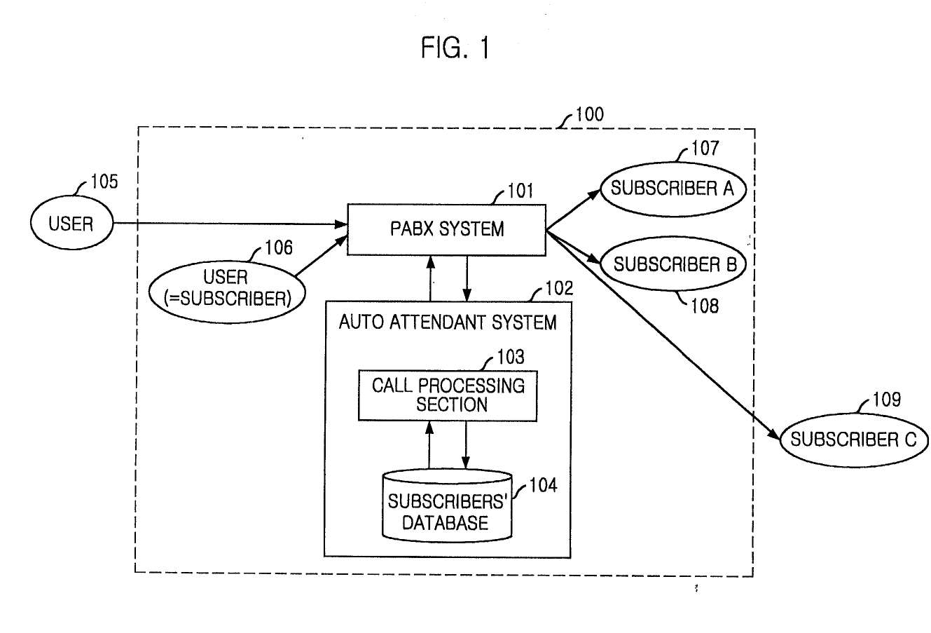

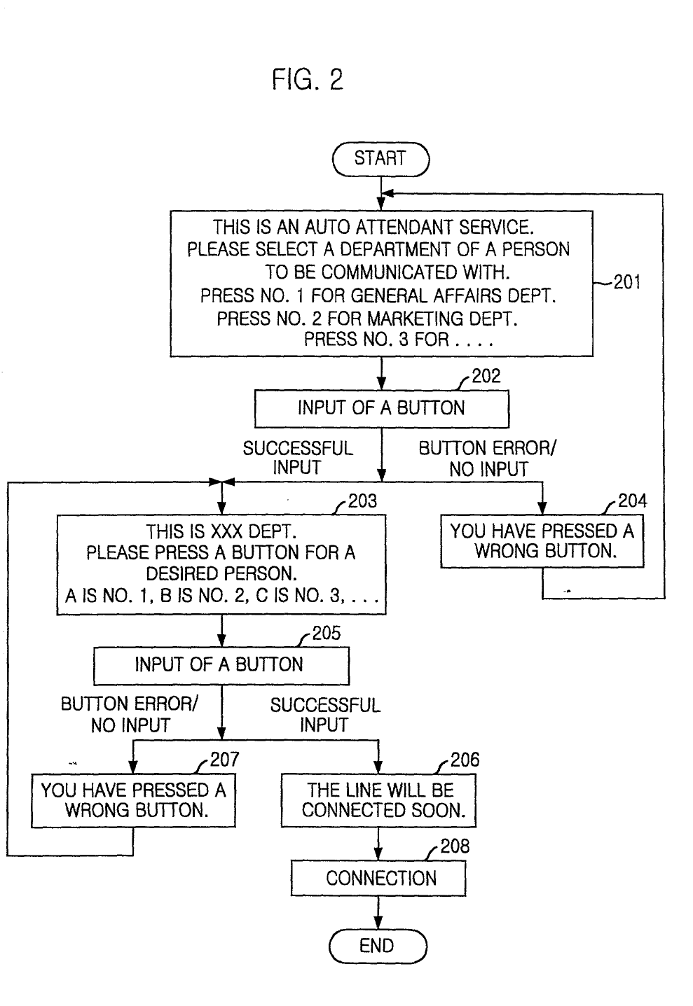

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

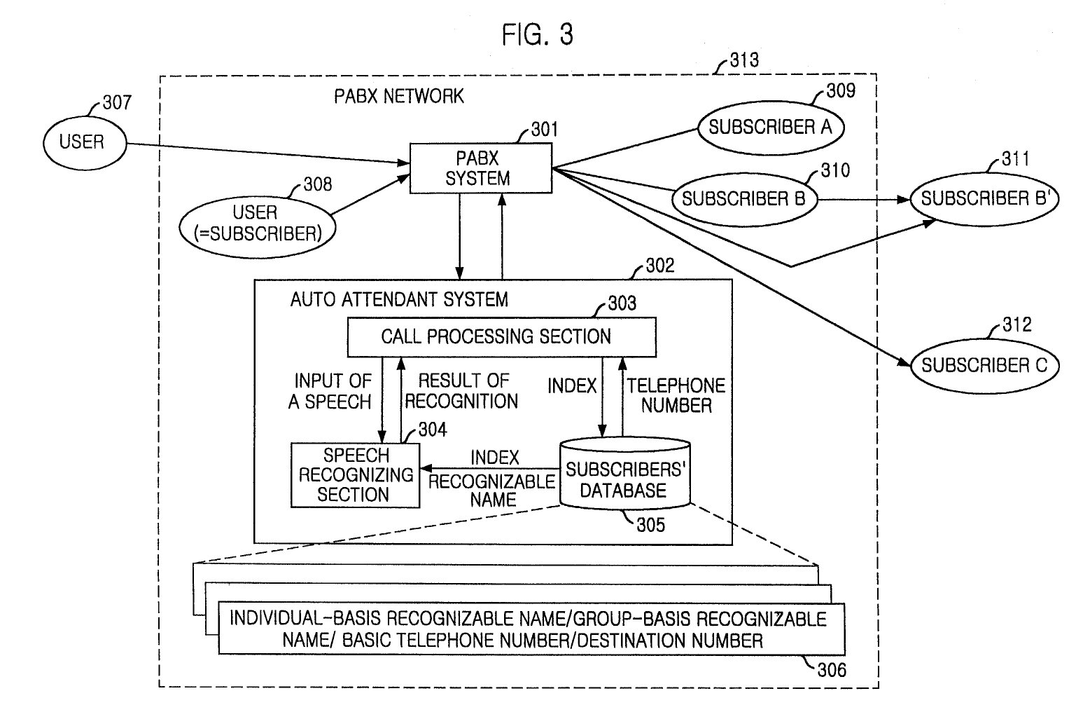

FIG. 3 is a block diagram illustrating a construction of an auto attendant system using a speech recognition according to an embodiment of the present invention.

An embodiment of the present invention assumes that an auto attendant system 302 is installed in a PABX network 313.

The auto attendant system 302 using a speech recognition includes a call processing section 303, a speech recognizing section 304, and a subscribers' database 305.

The speech recognizing section 304 registers an index and recognizable names as a recognition object list by receiving the same from the subscribers' database 305.

The call processing section 303 receives speeches from the subscribers who have accessed the auto attendant system 302, and transfers the same to the speech recognizing section 304. The speech recognizing section 304 performs a speech recognition, and transfers the result to the call processing section 303.

The call processing section 303 searches a destination telephone number of the subscriber selected from the subscribers' database based on the result of the speech recognition, and dials the searched number through the call processing section 303.

A call is directly forwarded to the destined line when a subscriber 310 has set a call forwarding to an external line 311, i.e., when information on a call forwarding has been changed to new information on a call forwarding (destination number) inputted through speech by recognizing the intention of a call forwarding and information on a subscriber inputted through speech by the subscriber who desires a call forwarding and by searching the information on a call forwarding of the subscriber stored in the subscribers' database 305.

The subscribers' database 305 stores the subscribers' information including the recognizable names, classified index values, connectable telephone numbers, etc. as well as the information related to call forwarding for processing of the call forwarding. A detailed description will be omitted here concerning the process that the auto attendant system 302 extracts characteristic data of the speech inputted by the user from the speech recognizing section 304, and searches a word most similar to the registered words list based on the result of the extracted characteristic vector. Such a process is nothing more than a technology well known in the pertinent art.

If the user who has accessed the auto attendant system 302 speaks the recognizable name of a subscriber to be communicated with, the auto attendant system recognizes the speech, and searches the subscribers' database 305 to connect the call to the subscriber's destination number.

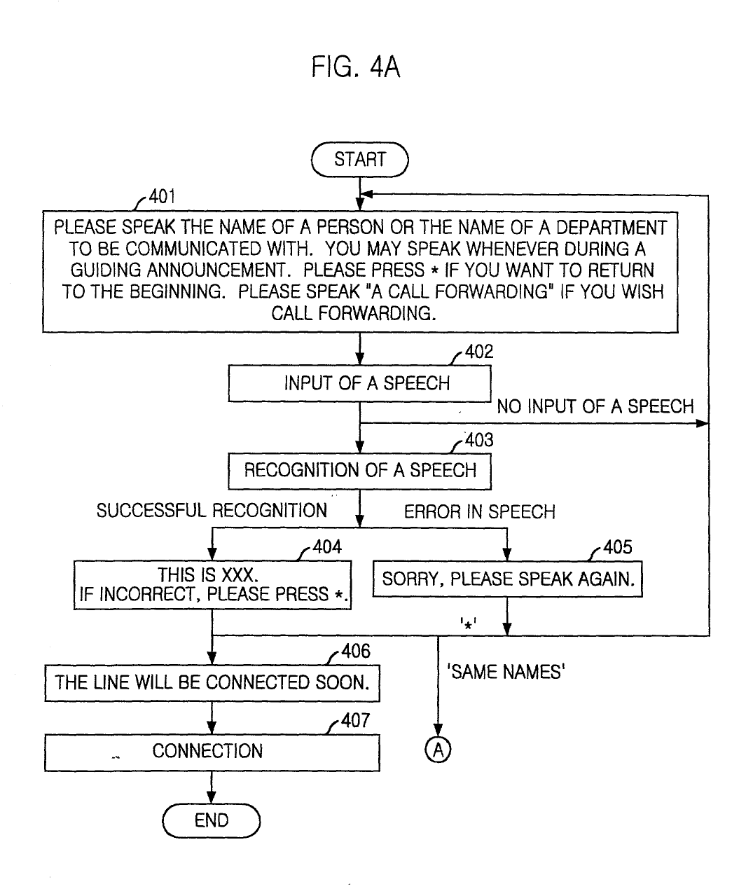

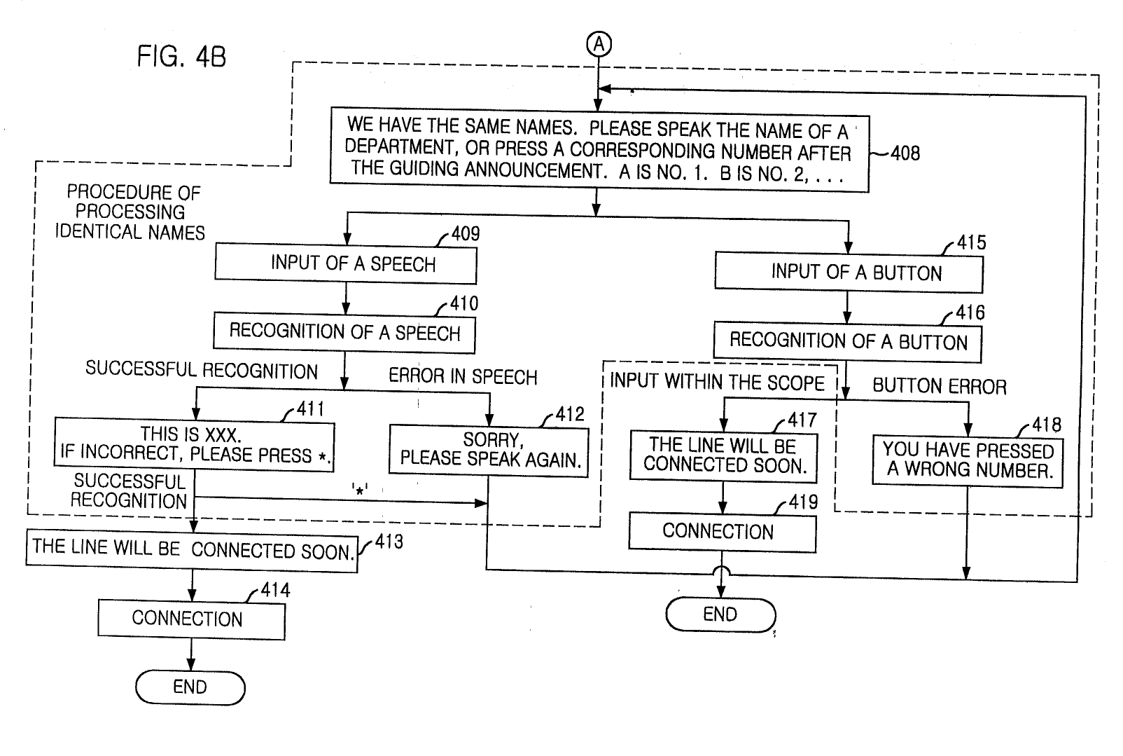

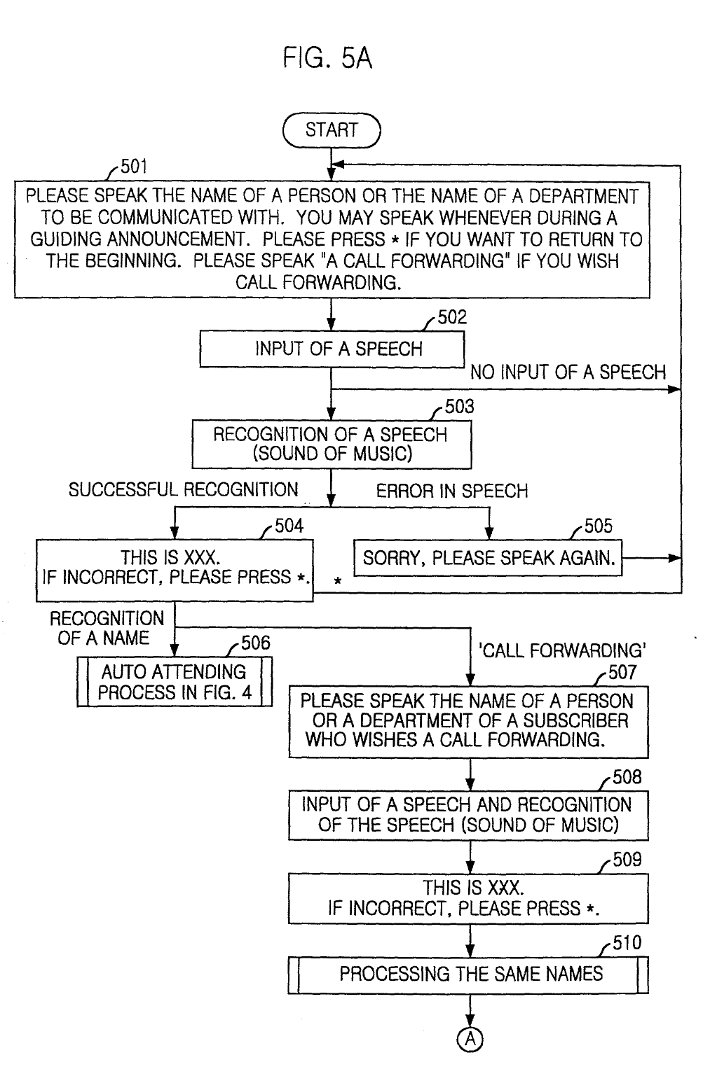

FIGS. 4A and 4B are flow charts illustrating an auto attending method using a speech recognition according to an embodiment of the present invention.

The following is an example of a case of connecting a call from a user after receiving a recognizable name of an employee (a subscriber) to be communicated with by the user when the auto attendant system using a speech recognition has been installed in a PABX network at a company. It is out of question that the auto attendant system using a speech recognition may be used by being connected to a public network in the absence of a PABX system.

Here, each subscriber has an individual-basis recognizable name, which is unique except some cases. A group-basis recognizable name is a higher concept of the individual-based recognizable name. If applying this structure to the professors' rooms of a university, a “department name” can be a group-basis recognizable name, while a “professor's name” can be an individual-basis recognizable name. Although the “professor's name” is generally unique, there may be some same names of the professors.

Once the user accesses the auto attendant system, at step 401, the system transmits a guiding announcement to guide the user to speak a recognizable name of the subscriber to be communicated with.

According to the guiding announcement, the user speaks the recognizable name of the subscriber at step 402. Here, the recognizable name of the subscriber is an individual-basis name of the subscriber.

The auto attendant system performs a recognition of the individual-basis recognizable name of the subscriber. If the name is not recognizable, it is processed as an error at step 405. If the name has been successfully recognized, the auto attendant system confirms the name at step 404, casts an announcement at step 406, and searches the subscribers' database to connect the call to the corresponding destination number at step 407.

However, if the individual-basis recognizable name is not unique but the same individual-basis recognizable name exists more than one, the auto attendant system casts an announcement to guide an input of a group-basis recognizable name of the subscriber so as to select an exact subscriber to be communicated with the user at step 408.

Here, an object of the group-basis recognizable name should cover two or more individual-basis recognizable names pertaining thereto.

If the user inputs a group-basis recognizable name of the subscriber at step 409, the auto attendant system recognizes the inputted group-basis recognizable name at step 410, and confirms an identity of the recognized name at step 411. If a result of the confirmation is positive, the auto attendant system selects the exact subscriber to be communicated with the user, and dials the destination number corresponding to the subscriber to connect the user to the subscriber at step 413. If a result of the confirmation is negative at step 412, the auto attendant system sends an error message, and returns to the step 408.

Such a process is applicable to where individual-basis recognizable names are unique except some cases. A group-basis recognizable name is recognized only when there exist two or more identically recognized individual-basis recognizable names. Therefore, easier and speedier services become available. Furthermore, an object of the group-basis recognizable names is confined to those consisting of already-confirmed individual-basis recognizable names. Therefore, the subscriber can be precisely identified.

The announcement through speech becomes simple because the object of the group-basis recognizable names is confined to those consisting of already-confirmed individual-basis recognizable names. Thus, it is possible to provide a method for inputting the group-basis recognizable name not only through speech but also by using a button corresponding to the group-basis recognizable name desired by the subscriber following an announcement of the group-basis recognizable names at steps 415 to 419.

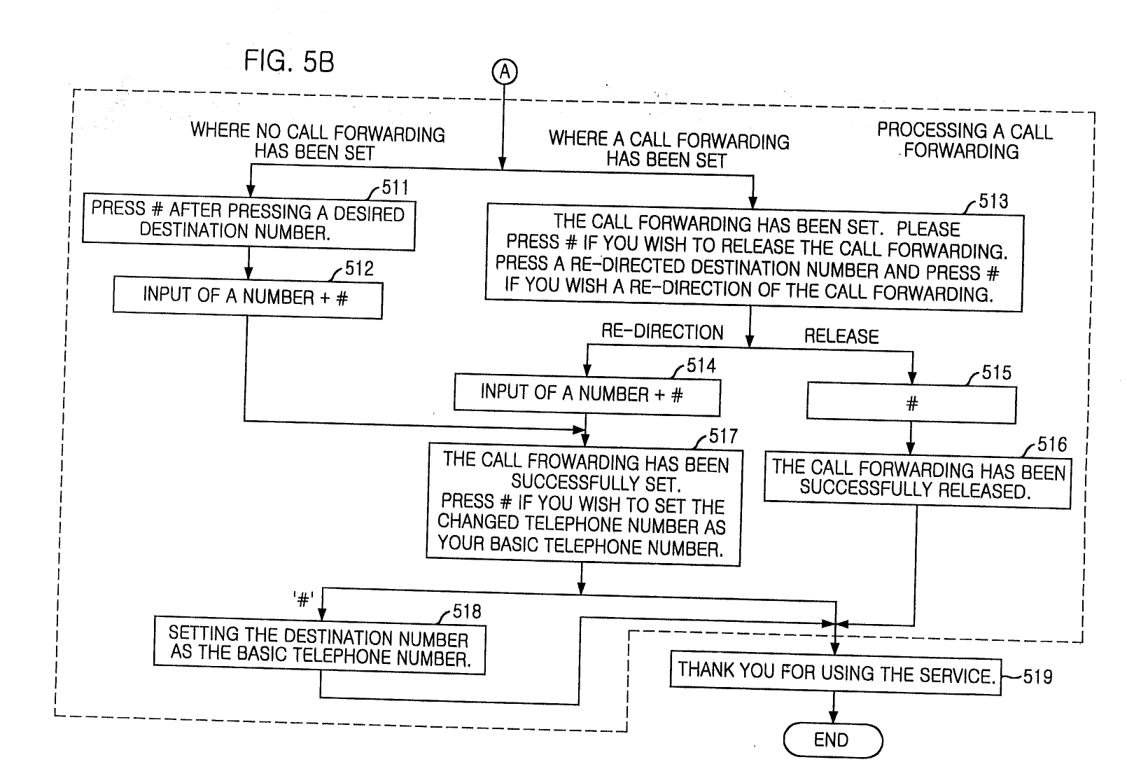

FIG. 5 is a flow chart illustrating a call forwarding method through a speech recognition according to an embodiment of the present invention. FIG. 5 shows a flow of a call forwarding service in an auto attendant system.

The call forwarding method using a speech recognition is ever applicable irrespective of the fact whether or not the auto attendant system is installed in a PABX network or in a public network.

If a subscriber registered in the auto attendant system desires to receive calls through another telephone line than his/her own line, the destination number desired by the subscriber is received by means of a call forwarding service. Then, the destination number stored in the subscribers' database is changed to a newly inputted destination number. If the user desires communication with the subscriber who has changed the destination number through the auto attendant system, the subscriber is automatically connected to the user by recognizing the speech inputted by the same manner as the auto attendant service.

The call forwarding service in the auto attendant system using a speech recognition is performed in the following manner. A subscriber first accesses the system through a network by means of a terminal such as a wired, a wireless telephone and a mobile telephone terminal. The auto attendant system then casts a guiding announcement to guide an approach to a call forwarding module at step 501.

If the subscriber speaks a “call forwarding” or inputs a corresponding key at step 502, the auto attendant system recognizes the inputted speech at step 503, and informs the recognized result to the subscriber at step 504 to confirm a precise recognition.

If the confirmation result finds that the precisely recognized speech is not a “call forwarding”, the call is connected by auto attendant service method as shown in FIGS. 4A and 4B, at step 506.

If the confirmation result finds that the speech has not been precisely recognized and the subscriber inputted the code “*”, the process newly begins from the beginning by returning to the step 501.

If the confirmation result finds that the precisely recognized speech is a “call forwarding”, the auto attendant system selects a call forwarding mode, and casts a guiding announcement to guide the subscriber to speak a recognizable name of the subscriber requiring the call forwarding at step 507.

If the subscriber's input of the speech is completed, the speech is recognized at step 508. Upon confirmation of the recognition result at step 509, the information on the corresponding subscriber is taken from the subscribers' database. If there exist two or more the same individual-basis recognizable names, an additional step is performed to receive a group-basis recognizable name in the same manner as the same name processing manner, at steps 408 to 412, 415, 416 and 418, shown in FIGS. 4A and 4B.

The auto attendant system then casts a guiding announcement to guide the subscriber to input a desired destination number at step 511. If the subscriber inputs a desired destination number at step 512, the destination number is renewed from the subscribers' database.

Here, the subscribers' database must remember the existing number to release setting of the call forwarding of the subscriber.

If the subscriber desires to release setting of the call forwarding, the subscriber approaches the call forwarding mode, and inputs the name of the subscriber who desires to release the setting of the call forwarding.

The auto attendant system subsequently confirms the recognized speech, and searches the subscribers' database to confirm whether or not the current subscriber is set for a call forwarding. In the affirmative, the auto attendant system casts an announcement inquiring whether or not to release the call forwarding at step 513, and receives a command requesting a release from the subscriber at step 515.

If the subscriber requires a call forwarding to a third line, the corresponding destination number is inputted by the same method as for setting a call forwarding at step 514.

If the subscriber desires to fix the destined number as his/her basic telephone number, the subscriber commands so by speech according to a guiding announcement at step 517. Then, the auto attendant system changes the basic telephone number of the subscriber to be the destined number at step 518.

The call forwarding processing in FIGS. 5A and 5B show a process of setting/releasing a call forwarding through input of a button. However, the present invention is not confined to using a speech recognition but is extended to using a button as well as an option for setting or releasing a call forwarding. Although the above description used the term “button” as input means for convenience sake, inputs are also available by means of a touch screen. The button and the touch screen can be referred to by a single term “auxiliary input means”.

When applied to an auto attendant system installed in a PABX network, the call forwarding method according to the present invention is capable of forwarding the calls to a subscriber to an outside call as well as an inside call. Moreover, since a line is occupied only when the call is forwarded to the outside call, the service becomes available for many more users.

As described above, the present invention realized an easier and speedier service for a user with a speech recognizing function provided for an auto attendant system. The present invention also realized a call forwarding to external lines as well for a subscriber registered in an auto attendant system installed in the PABX network irrespective of the kinds of PABX systems. The present invention further realized a direct setting and releasing of a destination number of a subscriber registered in an auto attendant system installed in a public network as well as in the PABX network. The present invention thus has a superior effect of providing a more convenient and effective auto attendant service.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. An auto attendant system using a speech recognition, comprising:
first storing means for storing information on a subscriber;
a first call processing means for receiving a recognizable name of the subscriber to be communicated with from a user to transfer the same to first speech recognizing means, and searching the information on the subscriber from the first storing means to connect a call to a destination number of the subscriber based on the searched information on the subscriber; and
first speech recognizing means for transferring the result of the recognized speech to the first call processing means by recognizing the speech transferred from the first call processing means.

2. The auto attendant system of claim 1, further comprising:
second storing means for storing information on a call forwarding;
second call processing means for receiving an intention for a call forwarding of calls to the subscriber, a recognizable name of the subscriber and new information on a call forwarding through speech to transfer the same to second speech recognizing means, receiving the result of the recognized speech from the second speech recognizing means, searching the information on call forwarding of the subscriber from the second storing means to change the same to the information on the new call forwarding, and connecting calls to the subscriber based on the changed information on the call forwarding; and
second speech recognizing means for recognizing the speech transferred from the second call processing means to transfer the result of the recognized speech to the second call processing means.

3. An auto attending method applicable to an auto attendant system, comprising the steps of:
a) receiving a recognizable name of the subscriber to be communicated with from the user for recognition of the inputted name; and
b) connecting a call to the destined telephone number of the subscriber based on the recognized name and stored information on the subscriber.

4. The auto attending method of claim 3, further comprising the step of c) receiving the recognizable name of the subscriber through auxiliary input means according to a selection of the user to connect the call to the destined telephone number of the subscriber based on the inputted information and the stored information on the subscriber.

5. The auto attending method of claim 3, wherein the step a) includes the steps of:
a1) receiving the recognizable name of the subscriber to be communicated with from the user through speech, and searching information on the subscriber by recognizing the inputted recognizable name through speech; and
a2) receiving and recognizing recognizable names of higher concepts until the recognizable name of the subscriber becomes unique, if the searched result in the step a1) finds a plurality of subscribers corresponding to the recognizable name through speech.

6. A call forwarding method applicable to an auto attendant system, comprising the steps of:
a) receiving and recognizing an intention for a call forwarding, a recognizable name and new information on a call forwarding of a subscriber who desires a call forwarding from the subscriber through speech; and
b) searching stored information on a call forwarding of the subscriber based on the recognized intention for a call forwarding and the recognizable name of the subscriber, changing the searched information to the new information on a call forwarding, and connecting calls to the subscriber by using the changed information on a call forwarding.

7. The call forwarding method of claim 6, further comprising the step of c) receiving the intention for a call forwarding, the recognizable name of the subscriber and the new information on a call forwarding through auxiliary input means according to a selection by the subscriber, searching the stored information on a call forwarding of the subscriber based on the inputted intention for a call forwarding and the recognizable name of the subscriber, changing the searched information on a call forwarding to the new information on a call forwarding, and connecting calls to the subscriber based on the changed information on a call forwarding.

8. The call forwarding method of claim 6, wherein the step a) includes the steps of:
a1) receiving and recognizing the intention for a call forwarding and the recognizable name of the subscriber through speech from the subscriber who desires a call forwarding, and searching the stored information on a call forwarding of the subscriber; and
a2) receiving and recognizing recognizable names of higher concept until the recognizable name of the subscriber becomes unique, if the searched result in the step a1) finds a plurality of subscribers corresponding to the recognizable name through speech.

9. A computer readable recording medium containing a program for executing an auto attending method applicable to an auto attendant system, the method comprising the steps of:
a) receiving a recognizable name of a subscriber to be communicated with a user from the user, and recognizing the inputted recognizable name; and
b) connecting calls to the subscriber to a destination telephone number of the subscriber based on the recognized recognizable name and the stored information on the subscriber.

10. A computer readable recording medium containing a program for executing a call forwarding method applicable to an auto attendant system, the method comprising the steps of:
a) receiving and recognizing an intention for a call forwarding and a recognizable name of a subscriber who desires a call forwarding through speech from the subscriber; and
b) searching the stored information on a call forwarding of the subscriber based on the recognized intention for a call forwarding and the recognizable name of the subscriber, changing the searched information to the new information on a call forwarding, and connecting calls to the subscriber based on the changed information on a call forwarding.
